(19) United States
(12) Patent Application Publication
(10) Pub. No.: US 2013/0097436 A1
(43) Pub. Date: Apr. 18, 2013

(54) SYSTEMS AND METHODS TO FILTER DATA PACKETS

(71) Applicants: Deepak Jindal KUMAR, Hyderabad (IN); Ashok Ranganath, San Diego, CA (US)

(72) Inventors: Deepak Jindal KUMAR, Hyderabad (IN); Ashok Ranganath, San Diego, CA (US)

(73) Assignee: QUALCOMM Incorporated, San Diego, CA (US)

(21) Appl. No.: 13/272,804

(22) Filed: Oct. 13, 2011

(51) Int. Cl. G06F 1/32

(52) U.S. Cl. 713/320

(57) ABSTRACT

A mobile communication device includes a receiver system configured to receive unicast data packets and non-unicast data packets. The receiver system may include a hardware packet filter. The mobile communication device further includes a processor coupled to the receiver system. The processor may be configured to detect a power state change and activate the hardware packet filter at the receiver system in response to the power state change indicating a power-conservation state being entered. When the hardware packet filter is activated, the unicast data packets received at the receiver system may be provided to the processor to be filtered and the non-unicast data packets received at the receiver system are dropped at the receiver system. When the hardware packet filter is not activated, the unicast data packets and the non-unicast data packets received at the receiver system may be provided to the processor.

### I. FIELD

The present disclosure is generally related to filtering data packets received at a mobile communication device.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application that can be used to access the Internet. As such, these wireless telephones can include significant computing capabilities.

In a wireless local area network (WLAN), a group of stations may communicate information with one another or via a network through an access point. The access point may be connected to a wired network and may act as a center of distribution for the WLAN. That is, the stations may communicate with one another via the access point.

Information may be communicated via data packets transmitted via the WLAN to the stations. A particular station may include a receiver that receives data packets and provides the data packets to a processor of the particular station. The processor may filter the data packets using software executed by the processor (i.e., “software filtering” of the data packets).

### III. SUMMARY

A wireless receiver system of a mobile communication device (e.g., a smart phone device) may receive data packets from a mobile communication network. The mobile communication device may filter the received data packets using software filtering when the mobile communication device is not in a power-conservation state. When the mobile communication device is in a power-conservation state (e.g., a standby mode, a sleep mode, a low-power mode, a deactivation state, etc.), the mobile communication device may use “hardware filtering” to filter the received data packets. The hardware filtering may be performed by the wireless receiver system and may be configurable by software associated with the mobile communication device. The hardware filtering may prevent some received data packets from being sent to a processor of the mobile communication device.

As an example, when the mobile communication device is in the power-conservation state, the wireless receiver system may perform hardware filtering to drop multicast data packets and/or broadcast data packets. The dropped data packets are not provided to the processor of the mobile communication device. As a result of dropping the data packets, the processor is not required to leave the power-conservation state to determine whether or not the received data packets are pertinent and, thus, power is conserved.

The hardware filtering may be configured to drop some, but not all, of the data packets received at the wireless receiver system of the mobile communication device. The hardware filtering may allow some data packets to be sent to the processor, which may cause the processor to exit the power-conservation state. For example, the hardware filtering may allow unicast data packets addressed to the mobile communication device to be passed by the wireless receiver system to the processor while non-unicast data packets are dropped.

The hardware filtering by the wireless receiver system may be activated and deactivated based at least in part on an indication of a power-conservation state associated with the mobile communication device. For example, hardware filtering may be activated when a component, system, or subsystem of the mobile communication device enters the power-conservation state. In a particular embodiment, the component, the system, or the subsystem may be associated with a display of the mobile communication device. To illustrate, hardware filtering may be activated when the display of the mobile communication device is deactivated (e.g., a display deactivated state) or when a sleep mode, a standby mode, or a low-power mode associated with a component, system, or subsystem of the mobile communication device is entered. Conversely, hardware filtering may be deactivated when the component, the system, or the subsystem of the mobile communication device exits the power-conservation state. In another particular embodiment, hardware filtering may be deactivated when the display of the mobile communication device is turned on (e.g., a display active state) or when the sleep mode, the standby mode, or the low-power mode associated with the component, the system, or the subsystem of the mobile communication device is exited.

The wireless receiver system may perform hardware filtering of the received data packets based on a transmission type used to send the data packets to the mobile communication device, a destination address associated with the data packets, or a combination of the transmission type and the destination address. The transmission type may include one of a unicast transmission and a non-unicast transmission. The non-unicast transmission may include broadcast transmissions and multicast transmissions. In a particular embodiment, the wireless receiver system may perform hardware filtering when the power-conservation state of the mobile communication device is activated. The hardware filtering may drop multicast data packets and/or broadcast data packets at the wireless receiver system and send unicast data packets directed to the mobile communication device to the processor of the mobile communication device. The unicast data packets sent to the processor may awaken the processor from a power-conservation state, thus enabling the processor to perform software filtering and other processing on the unicast data packets.

In a particular embodiment, a method includes detecting a power state change of a wireless device and activating hardware packet filtering at a receiver system of the wireless device in response to the power state change indicating the wireless device is entering a power-conservation state. When the hardware packet filtering is activated, unicast data packets received at the receiver system are provided to a processor of the wireless device and non-unicast data packets received at the receiver system are dropped at the receiver system. When the hardware packet filtering is not activated, the unicast data packets and the non-unicast data packets received at the receiver system are provided to the processor of the wireless device.

In a particular embodiment, a mobile communication device includes a receiver system configured to receive unicast data packets and non-unicast data packets, where the receiver system includes a hardware packet filter. The mobile communication device further includes a processor coupled to the receiver system. The processor is configured to detect a power state change and activate the hardware packet filter at the receiver system in response to the power state change indicating a power-conservation state being entered. When the hardware packet filter is activated, the unicast data packets received at the receiver system are provided to the processor to be filtered and the non-unicast data packets received at the receiver system are dropped at the receiver system. When the hardware packet filter is not activated, the unicast data packets and the non-unicast data packets received at the receiver system are provided to the processor.

In another particular embodiment, an apparatus includes means for detecting a power state change and means for activating hardware packet filtering at a receiver system in response to the power state change indicating entering a power-conservation state. When the hardware packet filtering is activated, unicast data packets received at the receiver system are provided to a processor to be filtered and non-unicast data packets received at the receiver system are dropped at the receiver system. When the hardware packet filtering is not activated, the unicast data packets and the non-unicast data packets received at the receiver system are provided to the processor.

In a further particular embodiment, a computer-readable medium includes instructions that, when executed by a processor, cause the processor to detect a power state change of a wireless device and activate hardware packet filtering at a receiver system of the wireless device in response to the power state change indicating the wireless device is entering or has entered a power-conservation state. When the hardware packet filtering is activated, unicast data packets received at the receiver system are provided to the processor to be filtered and non-unicast data packets received at the receiver system are dropped at the receiver system. When the hardware packet filtering is not activated, the unicast data packets and the non-unicast data packets received at the receiver system are provided to the processor.

Other aspects, advantages, and features of the present disclosure will become apparent after review of the entire application, including the following sections: Brief Description of the Drawings, Detailed Description, and the Claims.

### IV. BRIEF/DESCRIPTION OF THE DRAWINGS

FIG. 1 is a diagram of a particular illustrative embodiment of a system for mobile communications;

FIG. 2 is a flow chart of a particular illustrative embodiment of a method of filtering data packets at a mobile communication device; and

FIG. 3 is a diagram of a particular illustrative embodiment of a mobile communication device.

### V. DETAILED/DESCRIPTION

In a wireless network, a group of stations may communicate with one another or via a network through an access point. The access point may be connected to a wired network or another wireless network and may act as a center of distribution for the wireless network. For example, the stations may communicate with one another and with other devices via the access point. The access point may communicate information to the stations using unicast transmissions, broadcast transmissions, multicast transmissions, or a combination thereof. For example, to conserve bandwidth or for other purposes, some information may be sent to the stations via multicast transmission or broadcast transmission. To illustrate, information associated with particular applications may be broadcast or multicast. In order to determine which packets are directed to a particular station, the station may be adapted to filter received packets. For example, a processor of the station may execute software to filter the packets, referred to herein as “software filtering.” The processor may drop packets that are not directed to the station and may further examine packets that are directed to the station. For example, a receiver system of the station may provide received data packets to the processor which may execute instructions to determine whether each of the received data packets is pertinent to the station.

Some stations (e.g., mobile telephony devices, smart phone devices, mobile communication devices, etc.) may use a power-conservation function (e.g., a sleep function, a standby function, a low-power function, or a deactivation function) to power down the processor at particular times in order to conserve energy. When the stations use software filtering, a processor of a particular station may awaken to filter received packets even when the received packets are not pertinent to the particular station. In a particular embodiment, a receiver system of a wireless communication device is configured to filter received data packets when the wireless communication device is in a power-conservation state (e.g., a sleep state, a standby state, a low-power state, or a deactivated state). The receiver system may use hardware packet filtering (also referred herein as “hardware filtering”) to examine received data packets and to determine whether to provide the received data packets to the processor.

When particular received packets are provided to the processor, the processor may use software filtering to determine whether the particular packets are pertinent to the wireless communication device. Additionally, when the wireless communication device is not in the power-conservation state, the processor may use software filtering to filter received data packets. However, when the processor is in the power-conservation state, hardware packet filtering performed by the receiver system may drop certain packets without providing the dropped packets to the processor, thereby permitting the processor to remain in the power-conservation state. The particular packets dropped by the receiver system may be configurable by software stored in a memory of the wireless communication device. For example, in a particular embodiment, the receiver system may drop multicast and/or broadcast data packets that are received by the wireless communication device when the processor is in a power-conservation state. The receiver system may pass unicast data packets to the processor when the processor is in a sleep state thereby waking the processor in order for the processor to perform software packet filtering of the unicast data packets.

The hardware packet filtering by the receiver system may be activated or deactivated based on an indication related to the power-conservation state associated with the wireless communication device. The power-conservation state may be associated with a processor, a display, or another system or subsystem of the wireless communication device. For example, the hardware packet filtering may be activated when the display of the wireless communication device enters a power-conservation state (e.g., a display deactivated state). In another example, the hardware packet filtering may be activated when the processor enters a power-conservation state.

In a particular embodiment, components, systems, or subsystems of the wireless communication device may enter the power-conservation state upon occurrence of a triggering event. The hardware packet filtering may be activated responsive to any sleep or standby state associated with the processor, the receiver system, or other systems or subsystems of the wireless communication device.

When the wireless communication device leaves the power-conservation state (e.g., when the display becomes active again), the hardware packet filtering may be deactivated. For example, all data packets received while the wireless communication device is not in the sleep or standby state may be processed using software packet filtering at the processor.

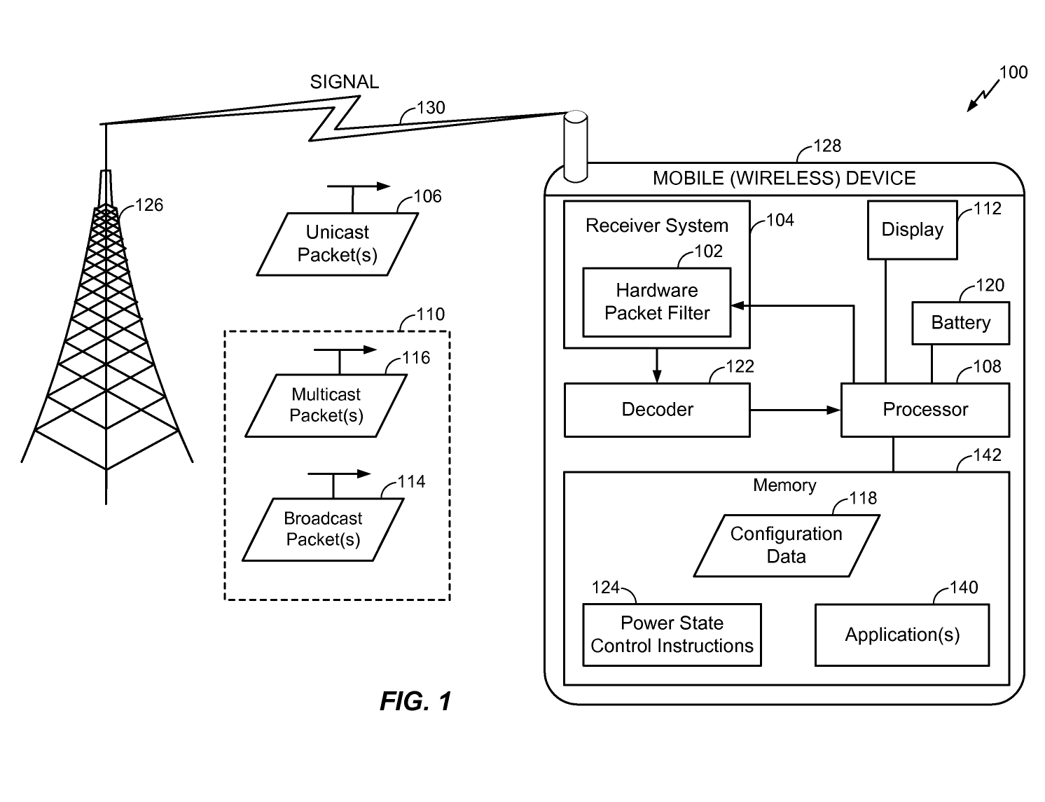

FIG. 1 depicts a first particular embodiment of a system 100 for mobile communications. The system 100 may include a wireless communication network 126, represented as an antenna tower in FIG. 1, and a wireless device 128. The wireless communication network 126 may be configured to transmit a communication signal 130 and the wireless device 128 may be adapted to receive the communication signal 130. In a particular embodiment, the wireless communication network 126 may include a wireless access point (not shown).

The wireless communication network 126 may send one or more data packets via the communication signal 130 to the wireless device 128. The one or more data packets transmitted by the wireless communication network 126 may include at least one of unicast data packets 106 and non-unicast data packets 110. The unicast data packets 106 may be directed to a communication address associated with a particular wireless device, such as the wireless device 128. The non-unicast data packets 110 may include multicast data packets 116, broadcast data packets 114, and/or other data packets (not shown). The wireless communication network 126 may transmit data using the non-unicast data packets 110, including the broadcast data packets 114, the multicast data packets 116, or both the broadcast data packets 114 and the multicast data packets 116. The non-unicast data packets 110 may be directed to broadcast addresses or multicast addresses associated with multiple wireless devices that may include the wireless device 128. Accordingly, the wireless device 128 may receive the unicast data packets 106 based at least in part on the communication address and may receive the non-unicast data packets 110 based at least in part on one of the broadcast addresses and/or the multicast addresses.

To illustrate, in a particular embodiment, the wireless communication network 126 may provide streaming media content (e.g., audio data and/or video data) to the wireless device 128 via the non-unicast data packets 110. In another particular embodiment, the wireless communication network 126 may transmit control features or control signals to the wireless device 128 via the non-unicast data packets 110 (e.g., the broadcast data packets 114 or the multicast data packets 116).

The wireless device 128 may include a receiver system 104, a decoder 122, a processor 108, a display 112, a battery 120, and a memory 142. The wireless device 128 may be a smart phone device, a smart wireless communication device, or another mobile communication device adapted to receive one or more data packets from the wireless communication network 126.

The receiver system 104 may be configured to receive data packets from the wireless communication network 126. The received data packets may be provided to the processor 108 via the decoder 122. The decoder 122 may decode the received data packets before the processor 108 receives the data packets. In a particular embodiment, the receiver system 104 may include a wireless receiver system (e.g., a WiFi receiver system). In another particular embodiment, the receiver system 104 may be included in a transceiver (not shown) as a component, a system, or a subsystem of the transceiver. The transceiver may be configured to communicate data (i.e., to transmit data and to receive data) between the wireless device 128 and the mobile communication network 126.

The receiver system 104 may include a hardware packet filter 102. In an alternative embodiment, the hardware packet filter 102 may be included in a component, a system, or a subsystem of the wireless device 128 that is distinct from the receiver system 104. The hardware packet filter 102 may have an activated state and a deactivated state. A state (e.g., the activated state or the deactivate state) of the hardware packet filter 102 may be selected responsive to one or more commands received from the processor 108. The one or more commands may be based at least in part on power state control instructions 124 as described further below.

In a particular embodiment, the processor 108 sends a command to the hardware packet filter 102 indicating a power state change associated with the wireless device 128. For example, the command may indicate when a power-conservation state (e.g., a sleep state, a standby state, a low-power state, or a deactivated state) associated with the wireless devices 128 is being initiated, entered, or exited. The power-conservation state may include a standby mode, a sleep mode, a low-power mode, a deactivation state or another power-conservation state of a component, a system, or a subsystem of the wireless device 128. The hardware packet filter 102 may be activated in response to a command received from the processor 108 indicating that a power-conservation state is being initiated or entered. The hardware packet filter 102 may be deactivated in response to a command received from the processor indicating that a power-conservation state is being exited. The hardware packet filter 102 may be configured to operate in accordance with configuration data 118 provided to the hardware packet filter 102 from the memory 142 via the processor 108 as described further below.

The hardware packet filter 102 may determine whether a received data packet is a unicast data packet or a non-unicast data packet prior to filtering the received data packet. In a particular embodiment, the hardware packet filter 102 may determine whether the received data packet is a unicast data packet or a non-unicast data packet based at least in part on a data packet header associated with the received data packet. The data packet header may indicate that the received data packet is a unicast data packet or a non-unicast data packet. In operation, after a particular data packet is received by the receiver system 104, at least the data packet header of the received data packet may be decoded. The hardware packet filter 102 may determine whether the received data packet is a unicast data packet or a non-unicast data packet based at least in part on a portion of the decoded packet header.

In another particular embodiment, the hardware packet filter 102 may identify whether a particular data packet is a unicast data packet or a non-unicast data packet prior to the receiver system 104 receiving the particular data packet. For example, an access point of the wireless communication network 126 may broadcast a beacon (e.g., a beacon signal or a beacon data packet) prior to transmitting the particular data packet to the wireless device 128. The beacon may include an indicator to indicate whether the particular data packet to be transmitted after the beacon is a unicast data packet or a non-unicast data packet. For example, the indicator may include a particular bit that indicates whether the particular data packet transmitted after the beacon is a unicast data packet or a non-unicast data packet. The indicator may also indicate whether the particular data packet is a multicast data packet or a broadcast data packet. The wireless device 128 may receive the beacon via the receiver system 104 and provide at least the indicator to the hardware packet filter 102. Based at least in part on the indicator, the hardware packet filter 102 may filter the particular data packet associated with the beacon.

The processor 108 may be coupled to the display 112 and to the battery 120. The battery 120 may be coupled to one or more components, systems, or subsystems of the wireless device 128. For example, the battery 120 may be coupled to the receiver system 104, the processor 108, the display 112, the decoder 122, and the memory 142. Operating in the power-conservation state may reduce a current drain of the battery 120 and extend a time period in which the battery 120 may power the wireless device 128.

The memory 142 may include the configuration data 118, the power state control instructions 124, and applications 140. The configuration data 118 may specify settings associated with the wireless device 128 that control operation of the wireless device 128. For example, the settings may include user settings, default settings, settings specified by the wireless communication network 126, setting specified by the applications 140, or settings specified by applications (e.g., software) that are external to the wireless device 128. In a particular embodiment, at least a portion of the configuration data 118 may be associated with hardware filtering of data packets received at the receiver system 104 of the wireless device 128. For example, the configuration data 118 may specify one or more particular data packet types to be dropped at the receiver system 104 when hardware filtering is active. To illustrate, the configuration data 118 may indicate that, during hardware filtering, the receiver system 104 should drop the broadcast data packets 114, the multicast data packets 116, or both the broadcast data packets 114 and the multicast data packets 116.

Further examples are provided regarding the manner in which the configuration data 118 may be configured to specify particular types of data packets that are to be filtered. In a particular embodiment, the configuration data 118 may indicate that unicast data packets 106 directed to the wireless device 128 and received by the receiver system 104 are to be provided to the processor 108 even when the processor 108 is in the power-conservation state. Alternatively, the configuration data 118 may indicate that the unicast data packets 106 are to be filtered at the receiver system 104 by the hardware packet filter 102.

In another embodiment, the configuration data 118 may indicate that multicast data packets 116 that are directed to particular multicast addresses are to be provided to the processor 108 even when the processor 108 is in the power-conservation state. Alternately, the configuration data 118 may indicate that all multicast data packets 116 directed to particular multicast addresses are to be filtered by the hardware packet filter 102 and dropped at the receiver system 104 rather than being provided to the processor 108.

In yet another embodiment, the configuration data 118 may indicate that broadcast data packets 114 received by the wireless device 128 and directed to particular broadcast addresses are to be provided to the processor 108. Alternately, the configuration data 118 may indicate that the broadcast data packets 114 directed to particular broadcast addresses or all broadcast data packets 114 are to be filtered at the hardware packet filter 102 and are not to be provided to the processor 108 when the processor 108 is in the power-conservation state.

The configuration data 118 may specify other types or combinations of data packets to be filtered at the hardware packet filter 102. For example, unicast data packets 106 directed to particular ports or other addresses associated with at least one particular application of the applications 140 may be dropped by the hardware packet filter 102 or may be provided to the processor 108 based on the configuration data 118. Likewise, when the processor 108 is in the power-conservation state, all multicast data packets 116, all broadcast data packets 114, or multicast data packets 116 or broadcast data packets 114 directed to particular addresses may be dropped by the hardware packet filter 102 or provided to the processor 108 based on the configuration data 118. When the processor 108 is not in the power-conservation state, the unicast data packets 106 and the non-unicast data packets 110 (including the broadcast data packets 114 and the multicast data packets 116) may be provided to the processor 108 for software packet filtering.

The memory 142 may also include the power state control instructions 124. The power state control instructions 124 may be adapted to cause a component (e.g., the processor 108 or the display 112), a system, or a subsystem of the wireless device 128 to enter a power-conservation state (e.g., a sleep state, a standby state, a low-power state, or a deactivated state) to conserve power. In an embodiment, the power state control instructions 124 may cause the component, the system, or the subsystem of the wireless device 128 to enter the power-conservation state upon occurrence of a triggering event. The triggering event may be related to a time period or an indication of inactivity associated with the component, the system, or the subsystem of the wireless device 128. The triggering event may be specified by the configuration data 118.

The memory 142 may also include the applications 140. The applications 140 may include one or more applications that receive data from the wireless communication network 126 via the unicast data packets 106, via the non-unicast data packets 110, or both. For example, the applications 140 may include one or more media applications, game applications, device operation applications, etc. Each of the applications 140 may be associated with a port of the wireless devices 128.

The processor 108 may be coupled to the memory 142 and may be adapted to access the configuration data 118, the power state control instructions 124, and the applications 140 stored in the memory 142. The processor 108 may be configured to execute the power state control instructions 124 and/or the applications 140. In a particular embodiment, the processor 108 is configured to access the configuration data 118 stored in the memory and to control functionality of the wireless device 128 responsive to the configuration data 118. In another particular embodiment, the processor 108 is configured to access and forward all or a portion of the configuration data 118 to a component, a system, or a subsystem of the wireless device 128. For example, the processor 108 may access the configuration data 118 and provide at least a portion of the configuration data 118 to the receiver system 104.

In operation, the processor 108 may enter the power-conservation state responsive the power state control instructions 124 and the configuration data 118. When the processor 108 enters the power-conservation state, the processor 108 may activate the hardware packet filter 102. For example, the configuration data 118 may indicate that hardware packet filtering is to be turned on (i.e., activated) at the hardware packet filter 102 when the display 112 turns off (e.g., becomes deactivated). Accordingly, when the display 112 turns off, the processor 108 may activate the hardware packet filter 102. Additionally, the processor 108 may provide information to the receiver system 104 indicating which particular packets are to be filtered or dropped at the receiver system 104 rather than being provided via the decoder 122 to the processor 108.

Simulations performed related to a particular hardware platform of a wireless device, such as the wireless device 128, indicate that when the display 112 is active, hardware packet filtering at the receiver system 104 provides little power savings at the battery 120 relative to the power drawn from the battery 120 by the display 112 when the display 112 is activated. Additional simulations indicate that when the display 112 is deactivated, a significant power savings may be realized by utilizing hardware packet filtering rather than software packet filtering. Thus, significant power savings may be gained by tying activation of the hardware packet filter 102 to a state (e.g., an active state or a deactivated state) associated with the display 112. Accordingly, the configuration data 118 may by default indicate that the hardware packet filter 102 is to be activated when the display 112 is deactivated. Further, the configuration data 118 may indicate that unicast data packets 106 are to be provided to the processor 108 while the display 112 is deactivated, and non-unicast data packets 110 are to be filtered at the hardware packet filter 102 while the display 112 is deactivated.

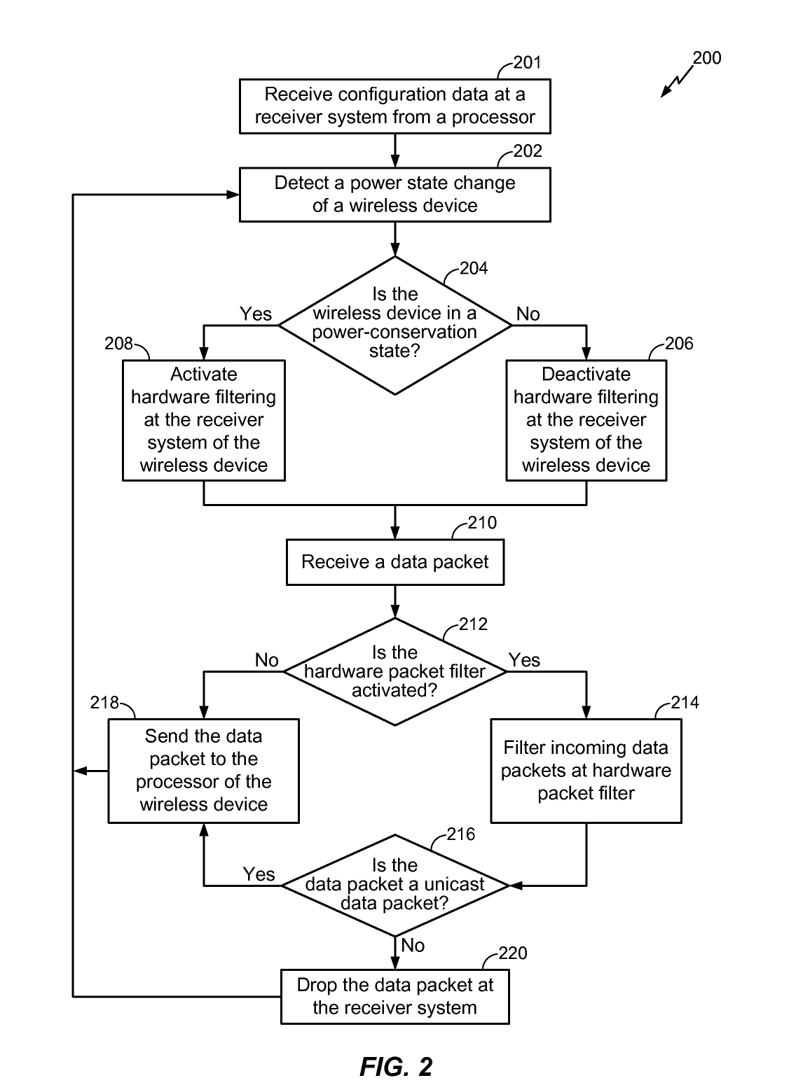

FIG. 2 illustrates a flowchart of a particular illustrative embodiment of a method of filtering data packets at a wireless communication device. The method 200 includes receiving configuration data at a receiver system from a processor, at 201. For example, the receiver system 104 of FIG. 1 may receive the configuration data 118 from the processor 108 of the wireless device 128.

The method 200 includes detecting a power state change of the wireless communication device, at 202. For example, the power state control instructions 124 of FIG. 1 may indicate that the wireless device 128 has entered a power-conservation state. The power-conservation state may be related to deactivation or standby of a processor 108 of the wireless device 128, deactivation or standby of a display 112 of the wireless device 128, or deactivation or standby of another component, system, or subsystem of the wireless device 128.

The method 200 may also include determining whether the wireless communication device has entered a power-conservation state, at 204. When the wireless communication device is not in a power-conservation state, hardware packet filtering of the receiver system of the wireless device may be deactivated, at 206. For example, the hardware packet filter 102 of FIG. 1 may be deactivated at the receiver system 104 in response to a command from the processor 108 responsive to the power state control instructions 124 and the configuration data 118.

When the wireless communication device is in a power-conservation state, hardware packet filtering may be activated in a receiver system of the wireless communication device, at 208. For example, the hardware packet filter 102 of FIG. 1 may be activated at the receiver system 104 in response to a command from the processor 108 responsive to the power state control instructions 124 and the configuration data 118.

The method 200 may also include receiving a data packet, at 210. For example, the receiver system 104 of the wireless device 128 of FIG. 1 may receive a data packet via the signal 130. The data packet may be a unicast data packet 106 or a non-unicast data packet 110. The non-unicast data packet 110 may include a broadcast data packet 114, a multicast data packet 116, or another type of data packet.

In a particular embodiment, the method 200 may include determining whether hardware packet filtering is activated, at 212. When hardware packet filtering is activated, the data packet may be filtered at the hardware packet filter, at 214. When hardware packet filtering is not activated, the data packet may be sent to a processor of the wireless device, at 218. For example, the hardware packet filter 102 may be activated in response to an activation command indicating a power-conservation state associated with the wireless device 128. When the hardware packet filter 102 is activated, the hardware packet filter 102 may filter data packets received at the receiver system 104 based at least in part on the configuration data 118. When the hardware packet filter 102 is not activated, the data packets received at the receiver system 104 may be provided to the processor 108 via the decoder 122.

When the hardware packet filter is activated, the method may include, at 216, determining whether a particular data packet is a unicast data packet. When the particular data packet is a unicast data packet, the data packet may be provided to the processor of the wireless device, at 218. After the data packet is provided to the processor of the wireless device, the method 200 may return to 202. When the particular packet is not a unicast data packet, the data packet may be dropped at the receiver system, at 220. After the data packet is dropped at the receiver system, the method 200 may return to 202. For example, the hardware packet filter 102 may filter data packets received by the receiver system 104 in accordance with the configuration data 118. The configuration data 118 may indicate that unicast data packets may be provided to the processor 108 during a power-conservation state. The configuration data 118 may further indicate that non-unicast data packets 110 are to be dropped by the receiver system 104 during a power-conservation state.

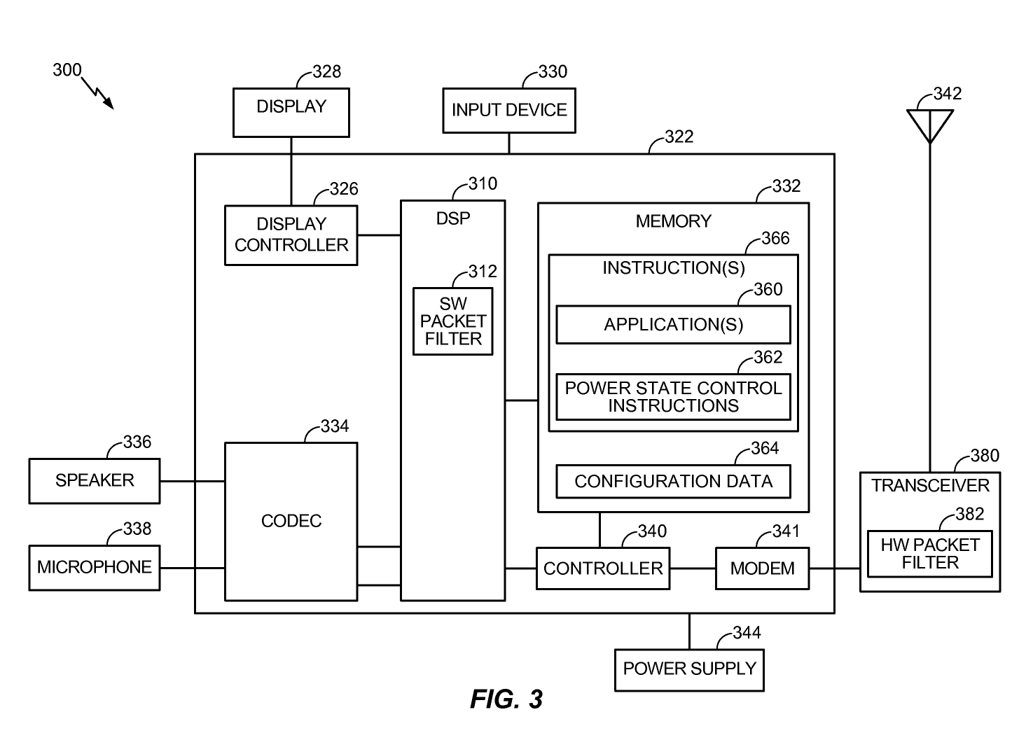

It should be noted that the method 200 of FIG. 2 may be implemented by a field-programmable gate array (FPGA) device, an application-specific integrated circuit (ASIC), a processing unit such as a central processing unit (CPU), a digital signal processor (DSP), a controller, another hardware device, firmware, or any combination thereof. As an example, the method 200 of FIG. 2 can be performed by a processor or component thereof that executes program code or instructions, as described with respect to FIG. 3.

Referring to FIG. 3, a block diagram of a particular illustrative embodiment of a wireless communication device is depicted and generally designated 300. In one embodiment, the wireless communication device 300 of FIG. 3 includes or is included within the wireless device 128 of FIG. 1. Further, all or part of the methods described in FIG. 2 may be performed at or by the wireless communication device 300 of FIG. 3. The wireless communication device 300 includes a processor, such as a digital signal processor (DSP) 310, coupled to a memory 332. In an illustrative embodiment, the DSP 310 may include the processor 108 of FIG. 1 and the memory 332 may include the memory 142 of FIG. 1.

FIG. 3 also shows a display controller 326 that is coupled to the digital signal processor 310 and to a display 328. A coder/decoder (CODEC) 334 can also be coupled to the digital signal processor (DSP) 310. A speaker 336 and a microphone 338 can be coupled to the CODEC 334. FIG. 3 also indicates that a controller 340 can be coupled to the digital signal processor 310 and to a modem 341 in communication with one or more wireless antennas (e.g., a wireless antenna 342) and at least one transceiver 380. The digital signal processor 310 may include a software packet filter 312.

The memory 332 is a non-transitory tangible computer readable storage medium that may store configuration data 364 and instructions 366. The instructions 366 may include applications 360 and power state control instructions 362. Further, the instructions 366 may embody one or more of the methods or logic as described herein. To illustrate, the instructions 366 may embody the method 200 of FIG. 2. Further, the applications 360, the power state control instructions 362, and the configuration data 364, may correspond to the applications 140, the power state control instructions 124, and the configuration data 118 of FIG. 1.

The transceiver 380 may be configured to receive data packets via antenna 342 and to provide the received data packets to the DSP 310. The received data packets may include unicast data packets and non-unicast data packets. For example, the unicast data packets and the non-unicast data packets may correspond to the unicast data packets 106 and the non-unicast data packets 110 of FIG. 1.

The transceiver 380 may include a hardware packet filter 382. The hardware packet filter 382 may have an active state and a deactivated state. When in the deactivated state, the transceiver 380 may provide all received data packets to the DSP 310. When in the active state, the hardware packet filter 382 may filter received data packets and cause one or more of the data packets to be dropped. The data packets to be dropped may be determined based at least in part on the configuration data 364. For example, the transceiver 380 may be the receiver system 104 of FIG. 1 and may function accordingly. Further, the hardware packet filter 382 may be the hardware packet filter of FIG. 1 and may function accordingly.

In a particular embodiment, the DSP 310, the display controller 326, the memory 332, the CODEC 334, the controller 340, and the modem 341 are included in a system-in-package or system-on-chip device 322. In a particular embodiment, the input device 330 and a power supply 344 are coupled to the system-on-chip device 322. Moreover, in a particular embodiment, as illustrated in FIG. 3, the display 328, the input device 330, the speaker 336, the microphone 338, the wireless antenna 342, the transceiver 380, and the power supply 344 are external to the system-on-chip device 322. However, each of the display 328, the input device 330, the speaker 336, the microphone 338, the wireless antenna 342, the transceiver 380, and the power supply 344 can be coupled to a component of the system-on-chip device 322, such as an interface or a controller.

In conjunction with the described embodiments, an apparatus is disclosed that includes means for detecting a power state change. For example, the means for detecting a power state change data may include the processor 108 of FIG. 1, the DSP 310 of FIG. 3, one or more devices configured to detect a power state change, or any combination thereof.

The apparatus may also include means for activating hardware packet filtering at a receiver system. Hardware packet filtering may be activated at the receiver system in response to a power state change that indicates that the apparatus is entering or has entered a power-conservation state. The power-conservation state may be associated with a component, system, or subsystem associated with the apparatus. When hardware packet filtering is activated, unicast data packets received at the receiver system are provided to a processor to be filtered, and non-unicast data packets received at the receiver system are dropped at the receiver system. When hardware filtering is not activated, the unicast data packets and the non-unicast data packets received at the receiver system are provided to the processor. For example, the means for activating hardware packet filtering at the receiver system may include the processor 108, the receiver system 104, or the hardware packet filter 102 of FIG. 1, the DSP 310, the transceiver 380, or the hardware packet filter 382 of FIG. 3, one or more devices configured to activate hardware filtering, or any combination thereof.

The apparatus may also include means for deactivating hardware packet filtering at a receiver system. Hardware packet filtering may be deactivated at the receiver system in response to a power state change indicating exiting of a power-conservation state. For example, the means for deactivating hardware packet filtering at the receiver system may include the processor 108, the receiver system 104, or the hardware packet filter 102 of FIG. 1, the DSP 310, the transceiver 380, or the hardware packet filter 382 of FIG. 3, one or more devices configured to deactivate hardware filtering, or any combination thereof.

The apparatus may also include means for receiving configuration data at a receiver system from a processor before detecting a power state change. The configuration data may specify one or more particular non-unicast data packet types that are to be dropped at the receiver system. The non-unicast data packet types may include broadcast data packets and multicast data packets. For example, the means for receiving configuration data at a receiver system from a processor before detecting a power state change may include the receiver system 104 or the hardware packet filter 102 of FIG. 1, the transceiver 380, or the hardware packet filter 382 of FIG. 3, one or more devices configured to receive configuration data, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal (e.g., a mobile phone or a PDA). In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments disclosed herein but is to be accorded the widest scope possible consistent with the principles and novel features as defined by the following claims.

What is claimed is:

1. A method comprising:
detecting a power state change of a wireless device; and
in response to the power state change indicating the wireless device entering a power-conservation state, activating hardware packet filtering at the wireless device;
wherein, when the hardware packet filtering is activated, unicast data packets received at a receiver system are provided to a processor of the wireless device to be filtered and non-unicast data packets received at the receiver system are dropped at the receiver system; and
wherein, when the hardware packet filtering is not activated, the unicast data packets and the non-unicast data packets received at the receiver system are provided to the processor of the wireless device.

2. The method of claim 1, further comprising deactivating the hardware packet filtering in response to the power state change indicating the wireless device exiting the power-conservation state.

3. The method of claim 1, wherein the power-conservation state is a standby state of the processor.

4. The method of claim 1, wherein the power-conservation state is a display deactivated state.

5. The method of claim 1, wherein the non-unicast data packets are broadcast data packets.

6. The method of claim 1, wherein the non-unicast data packets are multicast data packets.

7. The method of claim 1, further comprising receiving configuration data at the receiver system from the processor before detecting the power state change, wherein the configuration data specifies one or more particular non-unicast data packet types that are to be dropped at the receiver system.

8. A mobile communication device comprising:
a receiver system configured to receive unicast data packets and non-unicast data packets, the receiver system including or coupled to a hardware packet filter;
a processor coupled to the receiver system, the processor configured to:
detect a power state change; and
activate the hardware packet filter in response to the power state change indicating a power-conservation state being entered;
wherein, when the hardware packet filter is activated, the unicast data packets received at the receiver system are provided to the processor to be filtered and the non-unicast data packets received at the receiver system are dropped at the receiver system; and
wherein, when the hardware packet filter is not activated, the unicast data packets and the non-unicast data packets received at the receiver system are provided to the processor.

9. The mobile communication device of claim 8, wherein the processor is further configured to deactivate the hardware packet filter in response to the power state change indicating the power-conservation state being exited.

10. The mobile communication device of claim 8, wherein the power-conservation state is a standby state of the processor.

11. The mobile communication device of claim 8, wherein the power-conservation state is a display deactivated state.

12. The mobile communication device of claim 8, wherein the non-unicast data packets are broadcast data packets.

13. The mobile communication device of claim 8, wherein the non-unicast data packets are multicast data packets.

14. The mobile communication device of claim 8, wherein the processor is further configured to provide configuration data to the receiver system before detecting the power state change, wherein the configuration data specifies one or more particular non-unicast data packet types that are to be dropped at the receiver system.

15. An apparatus comprising:
means for detecting a power state change; and
means for activating hardware packet filtering in response to the power state change indicating entering of a power-conservation state;
wherein, when the hardware packet filtering is activated, unicast data packets received at a receiver system are provided to a processor to be filtered and non-unicast data packets received at the receiver system are dropped at the receiver system; and
wherein, when the hardware packet filtering is not activated, the unicast data packets and the non-unicast data packets received at the receiver system are provided to the processor.

16. The apparatus of claim 15, further comprising means for deactivating the hardware packet filtering in response to the power state change indicating exiting of the power-conservation state.

17. The apparatus of claim 15, wherein the power-conservation state is a standby state of the processor.

18. The apparatus of claim 15, wherein the power-conservation state is a display deactivated state.

19. The apparatus of claim 15, wherein the non-unicast data packets are broadcast data packets.

20. The apparatus of claim 15, wherein the non-unicast data packets are multicast data packets.

21. The apparatus of claim 15, further comprising means for receiving configuration data at the receiver system from the processor before detecting the power state change, wherein the configuration data specifies one or more particular non-unicast data packet types that are to be dropped at the receiver system.

22. A non-transitory computer-readable medium comprising instructions that, when executed by a processor, cause the processor to:
detect a power state change of a wireless device; and
in response to the power state change indicating the wireless device entering a power-conservation state, activate hardware packet filtering at the wireless device;
wherein, when the hardware packet filtering is activated, unicast data packets received at a receiver system are provided to the processor to be filtered and non-unicast data packets received at the receiver system are dropped at the receiver system; and
wherein, when the hardware packet filtering is not activated, the unicast data packets and the non-unicast data packets received at the receiver system are provided to the processor.

23. The non-transitory computer-readable medium of claim 22, further comprising instructions that, when executed by the processor, cause the processor to deactivate the hardware packet filtering in response to the power state change indicating the wireless device exiting the power-conservation state.

24. The non-transitory computer-readable medium of claim 22, wherein the power-conservation state is a standby state of the processor.

25. The non-transitory computer-readable medium of claim 22, wherein the power-conservation state is a display deactivated state.

26. The non-transitory computer-readable medium of claim 22, wherein the non-unicast data packets are broadcast data packets.

27. The non-transitory computer-readable medium of claim 22, wherein the non-unicast data packets are multicast data packets.

28. The non-transitory computer-readable medium of claim 22, further comprising instructions that, when executed by the processor, cause the processor to provide configuration data to the receiver system before detecting the power state change, wherein the configuration data specifies one or more particular non-unicast data packet types that are to be dropped at the receiver system.
